(19) United States
(12) Patent Application Publication
(10) Pub. No.: US 2005/0100396 A1
(43) Pub. Date: May 12, 2005

(54) Ring binder and ring binder mechanism

(76) Inventor: Arpad Barabas, Calgary (CA)

Correspondence Address: GOWLING LAFLEUR HENDERSON LLP, SUITE 1400, 700 2ND ST. SW, CALGARY, AB, T2P 4V5, CA

(21) Appl. No.: 10/978,404

(22) Filed: Nov. 2, 2004

Related U.S. Application Data
(60) Provisional application No. 60/518,290, filed on Nov. 10, 2003.

(51) Int. Cl. B42F 13/00

(52) U.S. Cl. 402/79

(57) ABSTRACT

A ring binder and ring binder mechanism are disclosed. The ring binder mechanism comprises: a pair of juxtaposed, rotatable members each with a plurality of half-ring elements, each of the half-ring elements pivotable into or out of contact with a mutually opposite half-ring element; protuberance means on the rotatable members; the rotatable members biased into an open position; and a slidably displaceable release-rod member with locking tab means on the release-rod member; wherein the release-rod member may be slidably displaced between a first position wherein the locking tab means are in engagement with the protuberance means such that the distal ends of respective pairs of half-ring elements are in contact, and a second position wherein the locking tab means are out of engagement with the protuberance means such that the distal ends of respective pairs of half-ring elements are not in contact.

### RELATED APPLICATIONS

Priority is claimed from U.S. provisional application 60/518,290 filed Nov. 10, 2003, entitled Ring Binder and Ring Binder Mechanism listing Arpad Barabas as inventor, such provisional application incorporated herein by reference.

### FIELD OF THE INVENTION

The present invention relates to ring binders and ring binder mechanisms, and more particularly to a ring binder mechanism adapted to be fixed to a base member such as a cardboard, plastic, or other type cover for forming a binder.

### BACKGROUND OF THE INVENTION

A number of prior art ring binder mechanisms exist, typically three-ring binder mechanisms, all adapted to retain perforated sheets in a binder. Specific examples of prior art ring binder mechanisms may be found in such patents as U.S. Pat. Nos. 5,975,784; 6,371,678; 6,036,394; 6,293,722; 5,836,709; 4,798,491; and 6,196,749.

A number of the prior art ring binders have mechanisms which bias the rings in a closed position, so that during closing the rings would snap shut, often noisily, and often trapping human digits, resulting in a painful experience for the user where the rings were large and strongly biased. The sometimes considerable biasing force also exerted stresses on the ring binder mechanism itself, sometimes leading to failure of the mechanism or at least requiring usage of more robust components, increasing the cost and weight of such a mechanism.

### SUMMARY OF THE INVENTION

In order to overcome certain of the disadvantages of the prior art, the present invention in a first aspect thereof comprises a ring binder mechanism for retaining perforated material in a binder, said mechanism comprising:
i) a pair of members arranged in juxtaposed position, each having a plurality of half-ring elements thereon, at least one of the members being a rotatable member pivotably rotatable about a longitudinal axis, each of the half-ring elements spaced on the members such that each half-ring element on each member, upon pivotable rotation of the at least one rotatable member, may be pivoted into or out of contact with a mutually opposite half-ring element on a respective opposite member;
ii) protuberance means situate on the at least one rotatable member along an inner edge thereof;
(iii) biasing means, biasing the at least one rotatable member into an open position wherein distal ends of respective pairs of half-ring elements are not in contact;
(iv) a release-rod member, slidably displaceable in a direction parallel the longitudinal axis; and
(v) locking tab means on the release-rod member;
   wherein the release-rod member may be slidably displaced between a first position wherein the locking tab means are in engagement with the protuberance means such that the distal ends of respective pairs of half-ring elements are in contact, and a second position wherein the locking tab means are out of engagement with the protuberance means such that the distal ends of respective pairs of half-ring elements are not in contact.

According to a second aspect of the present invention, there is provided a ring binder for retaining perforated material therein, comprising:
(i) a substantially flat, foldable binder member comprising: a spine portion; and substantially similarly-sized top and bottom members, each attached to the spine portion on opposite edges thereof, the top and bottom members adapted to be folded over onto each other with the spine portion intermediate; and
(ii) a ring binder mechanism affixed to the spine portion of the binder member, comprising: a pair of members arranged in juxtaposed position, each having a plurality of half-ring elements thereon, at least one of the members being a rotatable member pivotably rotatable about a longitudinal axis, each of the half-ring elements spaced on the members such that each half-ring element on each member, upon pivotable rotation of the at least one rotatable member, may be pivoted into or out of contact with a mutually opposite half-ring element on a respective opposite member; protuberance means situate on the at least one rotatable member along an inner edge thereof; biasing means, biasing the at least one rotatable member into an open position wherein distal ends of respective pairs of half-ring elements are not in contact; a release-rod member, slidably displaceable in a direction parallel the longitudinal axis; and locking tab means on the release-rod member;
   wherein the release-rod member may be slidably displaced between a first position wherein the locking tab means are in engagement with the protuberance means such that the distal ends of respective pairs of half-ring elements are in contact, and a second position wherein the locking tab means are out of engagement with the protuberance means such that the distal ends of respective pairs of half-ring elements are not in contact.

According to a third aspect of the present invention, there is provided a ring binder for retaining perforated material therein, comprising:
(i) a substantially flat, foldable binder member comprising: an elongate spine portion; and substantially similarly-sized top and bottom members, each attached to the spine portion at opposite edges thereof, the top and bottom members adapted to be folded over onto each other with the spine portion intermediate; and
(ii) a ring binder mechanism affixed to the spine portion of the binder member, comprising: a pair of elongate rotatable plates arranged in juxtaposed position, each having a plurality of half-ring elements thereon, the rotatable plates pivotably rotatable about respective and generally parallel longitudinal axes, each of the half-ring elements spaced on the rotatable plates such that each half-ring element on each rotatable plate, upon pivotable rotation of the rotatable plates, may be pivoted into or out of contact with a mutually opposite half-ring element on a respective opposite rotatable plate; protuberances situate on the rotatable plates along and integrally formed with inner edges thereof; springs situate beneath the rotatable plates and biasing the rotatable plates into an open position wherein distal ends of respective pairs of half-ring elements are not in contact; a release-rod, slidably displaceable in a direction parallel the longitudinal axes, the release-rod housed within a generally cylindrical housing, the release-rod resiliently biased by a spring into a first position; and locking tabs on the release-rod, the locking tabs extending outwardly from the cylindrical housing by means of apertures in the cylindrical housing;
   wherein the release-rod may be slidably displaced between the first position wherein the locking tabs are in engagement with the protuberances such that the distal ends of respective pairs of half-ring elements are in contact, and a second position wherein the locking tabs are out of engagement with the protuberances such that the distal ends of respective pairs of half-ring elements are not in contact.

In preferred embodiments of the present invention, the protuberance means, when the half-ring elements are moved into contact with each other, may be snap-fitted into locking engagement with the locking tab means so as to permit the locking tab means to retain the members and half-ring elements thereon in a closed position. Alternatively, the locking tab means may have an upper inclined bearing surface adapted to be contacted by the protuberance means when the half-ring elements are moved into contact with each other, so as to cause slidable displacement of the release-rod member in a direction parallel the longitudinal axis. The release-rod member is preferably resiliently biased to the first position whereby the locking tab means may engage the protuberance means and prevent pivotable rotation of the at least one rotatable member. Where the locking tab means have an upper inclined bearing surface, the release-rod member is preferably resiliently biased to the first position whereby the locking tab means may engage the protuberance means when the half-ring elements are in the closed position, wherein moving the half-ring elements from an open position to the closed position causes the protuberance means to contact the upper inclined bearing surface causing the release-rod member to be slidably displaced so as to permit the half-ring elements to move to the closed position, whereupon the release-rod member is subsequently biased to the first position permitting the locking tab means thereon to fully engage the protuberance means and thereby retain the half-ring elements in the closed position.

In preferred embodiments, both of the pair of members are elongate and generally parallel, and both are rotatable. The biasing means are preferably but not necessarily a compression spring, situate beneath each rotatable member. The release-rod member is preferably housed within a generally cylindrical housing, the generally cylindrical housing preferably comprising at least one aperture for allowing lateral movement of the locking tab means. The locking tab means preferably comprise an upwardly extending element having side extensions for retaining the protuberance means when engaged, and the release-rod member is preferably resiliently biased to the first position by means of a compression spring.

### BRIEF DESCRIPTION OF THE DRAWINGS

Further advantages and permutations will appear from the following detailed description of various non-limiting embodiments of the invention, taken together with the accompanying drawings, in which:

FIG. 1 is a perspective view of the ring binder and ring binder mechanism of the present invention, with the ring binder mechanism shown in the closed position;

FIG. 2 is a detailed view of the ring binder mechanism of FIG. 1 (closed position);

FIG. 3 is an enlarged cross-sectional view taken along line A-A of FIG. 1 in the direction of arrow “B” in FIG. 2;

FIG. 4 is a perspective view of the ring binder mechanism of the present invention, showing activation of the release-rod member to permit the ring binder mechanism to open;

FIG. 5 is a detailed view of the ring binder mechanism of FIG. 4 (open position);

FIG. 6 is an enlarged cross-sectional view taken along line B-B of FIG. 4 in the direction of arrow “D” in FIG. 5;

FIG. 7 is a cross-sectional view taken along line E-E of FIG. 4, with the release rod in the actuated position thereby allowing the ring binder mechanism to open;

FIG. 8 is an enlarged view of area “G” of FIG. 7;

FIG. 9 is a perspective view of the ring binder mechanism of the present invention, similar to the views shown in FIGS. 1 and 4, showing the release rod having returned to its original locking position but before the manual closing of the half-ring elements;

FIG. 10 is a cross-sectional view taken along line F-F of FIG. 9;

FIG. 11 is a simplified perspective view of the ring binder mechanism of the present invention, showing the position of the release-rod member when activated so as to permit the ring binder mechanism to open the rings;

FIG. 12 is a simplified perspective view of the ring binder mechanism of the present invention, showing the position of the release-rod member when the rings are in the closed position and the release-rod member is not activated;

FIG. 13 is a detailed view of the embodiment of the release-rod member shown in FIGS. 2, 3, 5, 6, 7, 8, 10, 11 and 12;

FIG. 14 is an alternative embodiment of the release-rod member;

FIG. 15 is yet another embodiment of the release-rod member forming a part of the ring binder mechanism of the present invention;

FIG. 16a is a detailed elevation view of an alternative embodiment of the biasing means, the ring binder mechanism in the closed position;

FIG. 16b is a detailed elevation view of the alternative embodiment of the biasing means of FIG. 16a, the ring binder mechanism in the open position;

FIG. 17a is a detailed perspective view of an alternative embodiment of the release-rod member biasing means (a “push-button” version, rather than pulling the release-rod member to activate), showing the locking tab means engaged with the protuberance means (the ring binder mechanism in the closed position);

FIG. 17b is a detailed perspective view of the alternative embodiment of FIG. 17a, showing the ring binder mechanism after the release-rod member has been pushed inwardly (second position) and the locking tab means have been disengaged from the protuberance means, the rotatable members being biased upwardly; and

FIG. 17c is a detailed perspective view of the alternative embodiment of FIGS. 17a and 17b, showing the ring binder mechanism after the release-rod member has returned to the first position with the locking means still disengaged from the protuberance means.

### DETAILED DESCRIPTION OF A PREFERRED EMBODIMENT

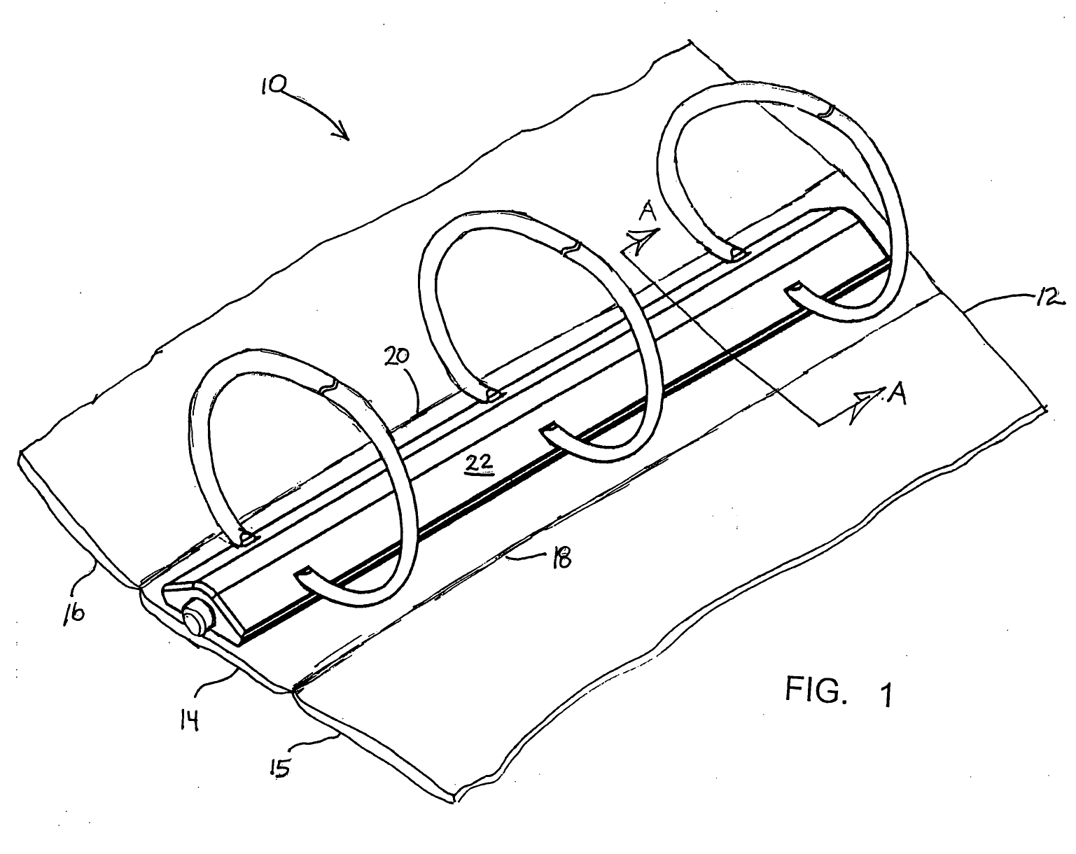

Referring now in detail to the accompanying drawings, there is illustrated a preferred embodiment of the ring binder and ring binder mechanism. FIG. 1 shows a ring binder 10 for retaining perforated material (not shown) therein. The ring binder 10 comprises a substantially flat, foldable binder member 12. The binder member 12 itself comprises a spine portion 14 and substantially similarly-sized bottom and top members 15, 16, each attached to the spine portion 14 along opposite edges 18, 20 thereof. The top and bottom members 15, 16 are each adapted, by means of the manner of being attached to the spine portion 14 on opposite edges 18, 20 thereof, such as by a fold or hinge or the like, to be folded over onto each other with the spine portion 14 intermediate.

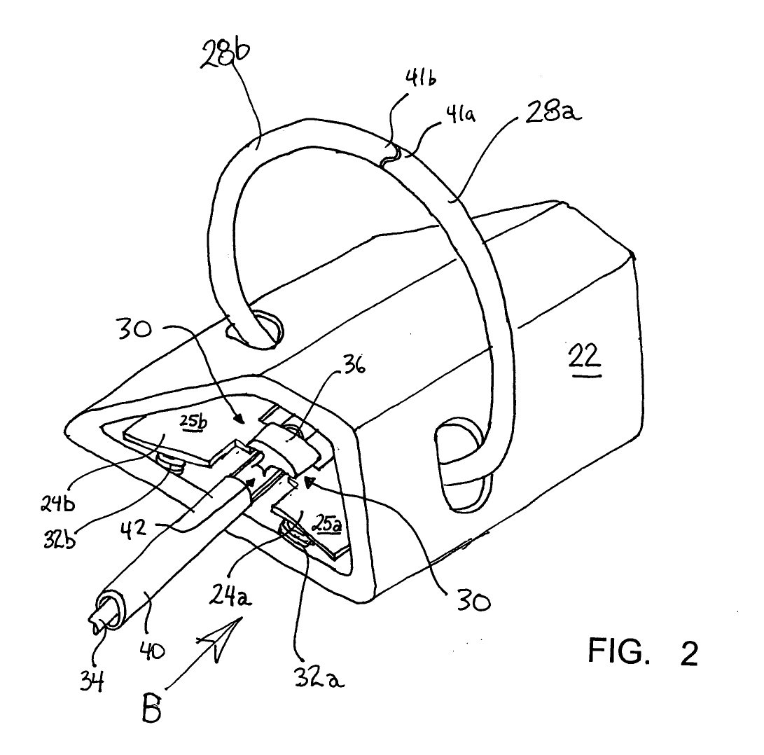

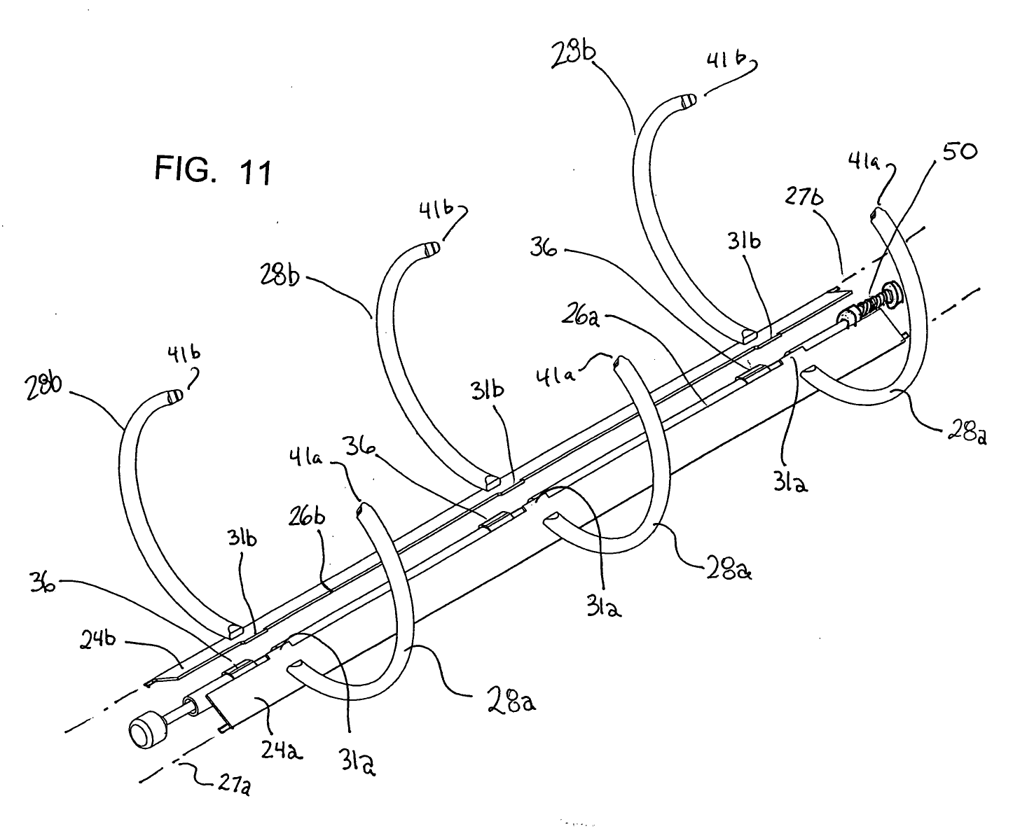

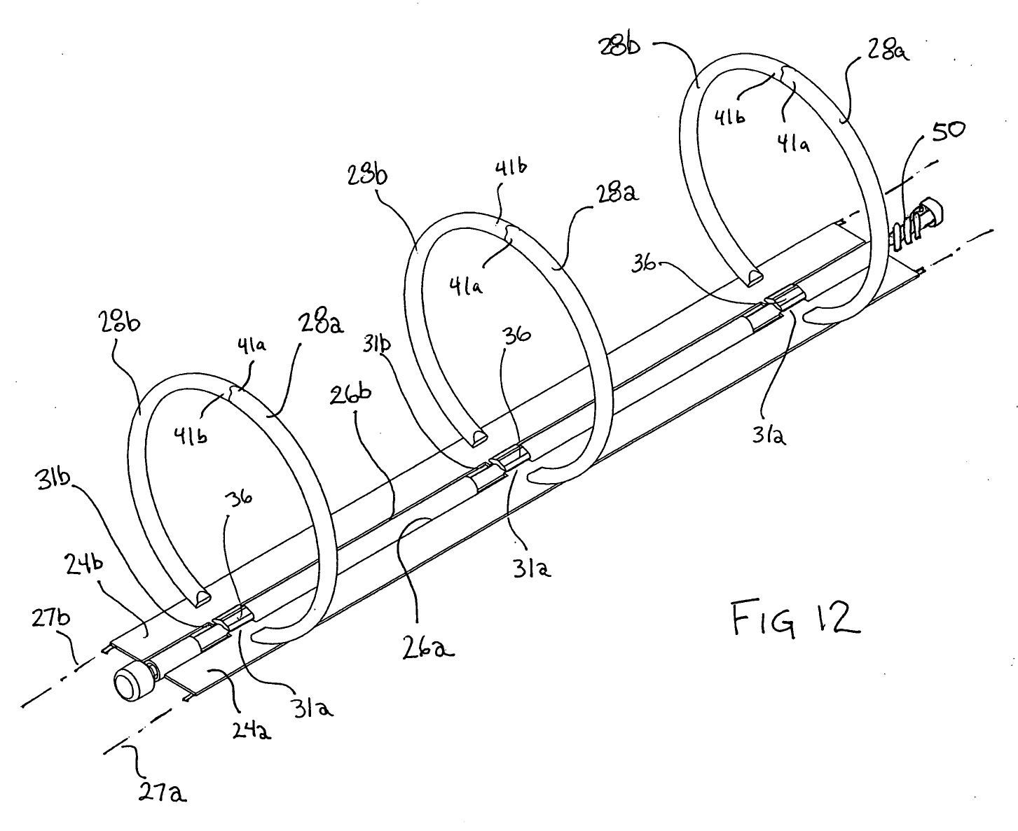

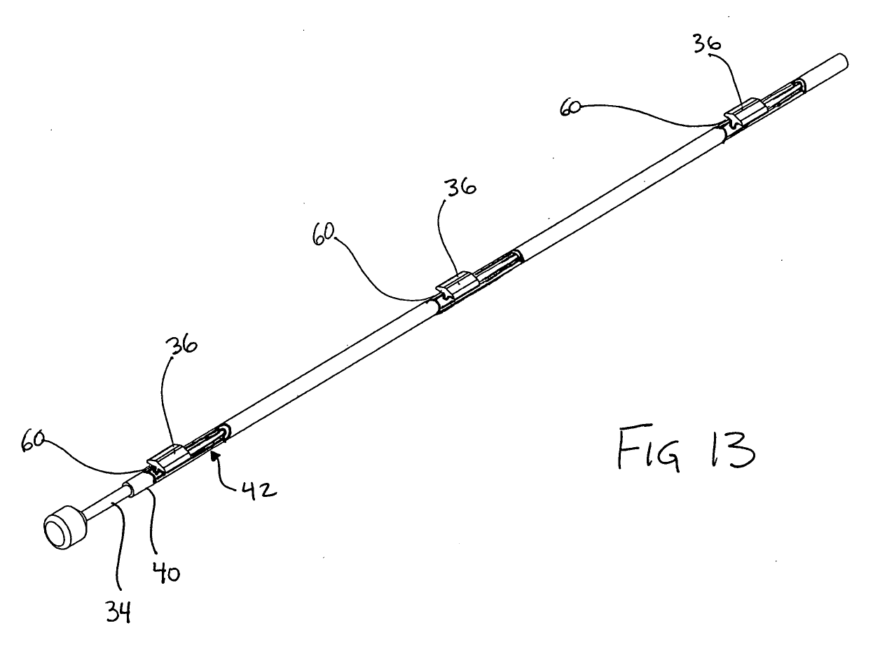

A ring binder mechanism 22, affixed to the spine portion 14 as shown in FIG. 1, is provided. As may be seen most clearly in the preferred embodiment of FIGS. 2, 3, 5, 6, and 10, and in the simplified views shown in FIGS. 11 and 12, the binder mechanism 22 comprises a pair of elongate, parallel rotatable members 24a, 24b which in the particular embodiment shown in the drawings are depicted as plate members 25a, 25b which are arranged side by side. Such rotatable members 24a, 24b may alternatively be cylindrical rods—their geometry is not of particular importance, provided that such members 24a, 24b be rotatable. However, as is known in the art of binder mechanisms, only one of such members 24a, 24b need be rotatable, provided that the half-ring elements 28a, 28b can be moved into and out of contact with each other.

As can best be seen in FIGS. 11 and 12, each of rotatable members 24a, 24b has an inner elongate edge 26a, 26b respectively, and each further has a plurality of half-ring elements 28a, 28b respectively thereon. The rotatable members 24a, 24b are each rotatable about a respective longitudinal axis 27a, 27b respectively. The half-ring elements 28a, 28b are mounted on the rotatable members 24a, 24b respectively so that upon pivotable rotation of each of the pair of rotatable members 24a, 24b, the half-ring elements 28a may be pivoted into or out of contact with mutually opposite half-ring elements 28b.

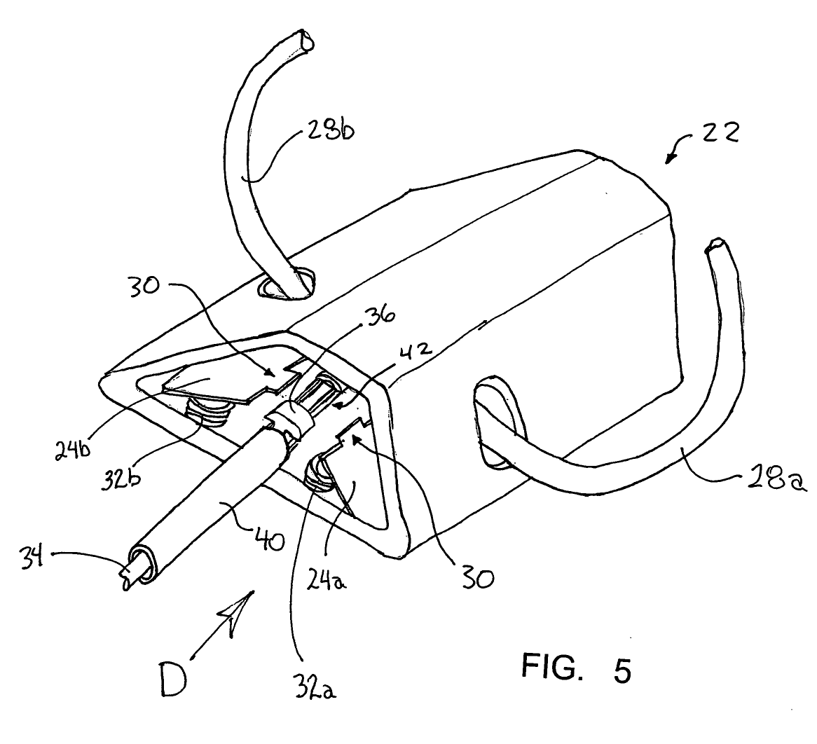

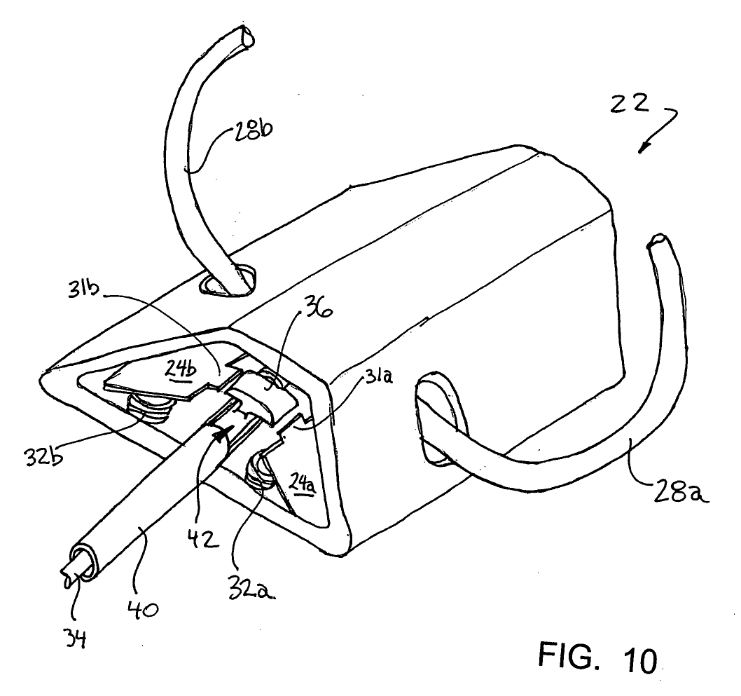

Protuberance means 30 (as seen in FIGS. 2 and 5), in the form of one or more protuberance tabs 31a, 31b (as seen in FIGS. 10, 11 and 12), are situate on each of respective rotatable members 24a, 24b, along the inner edge 26a, 26b respectively, as shown in FIGS. 11 and 12.

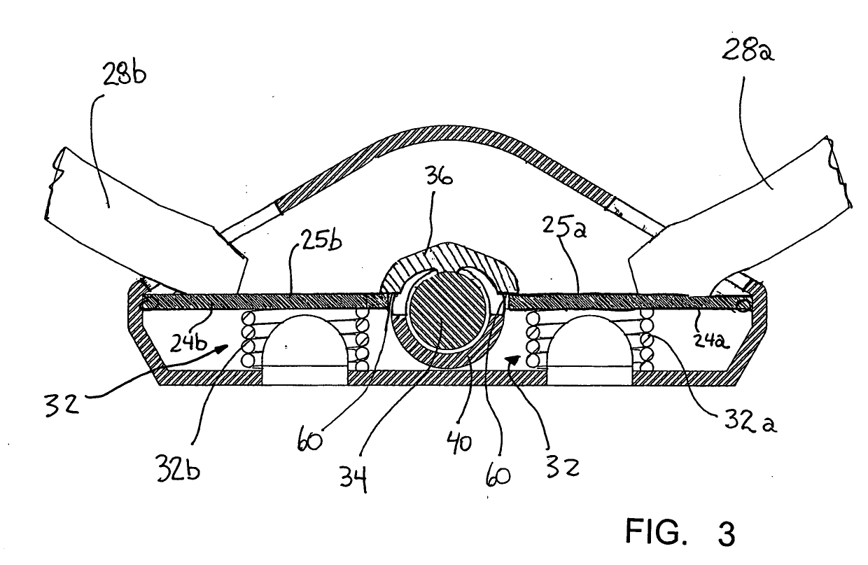

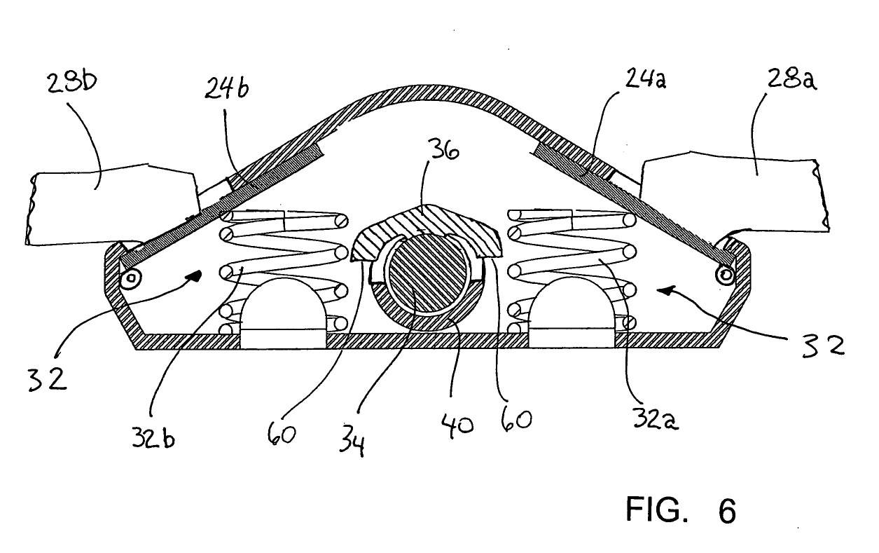

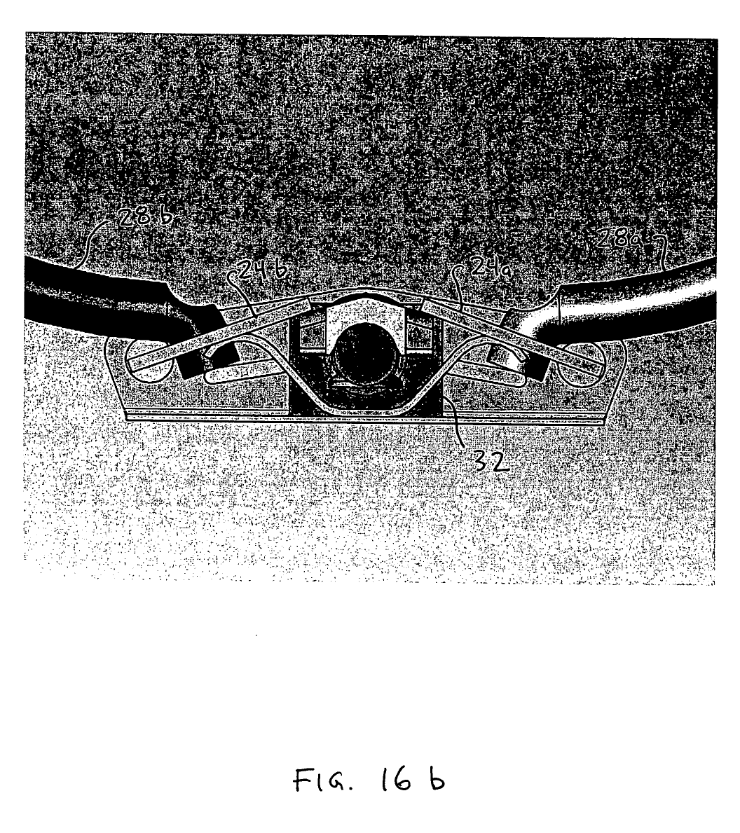

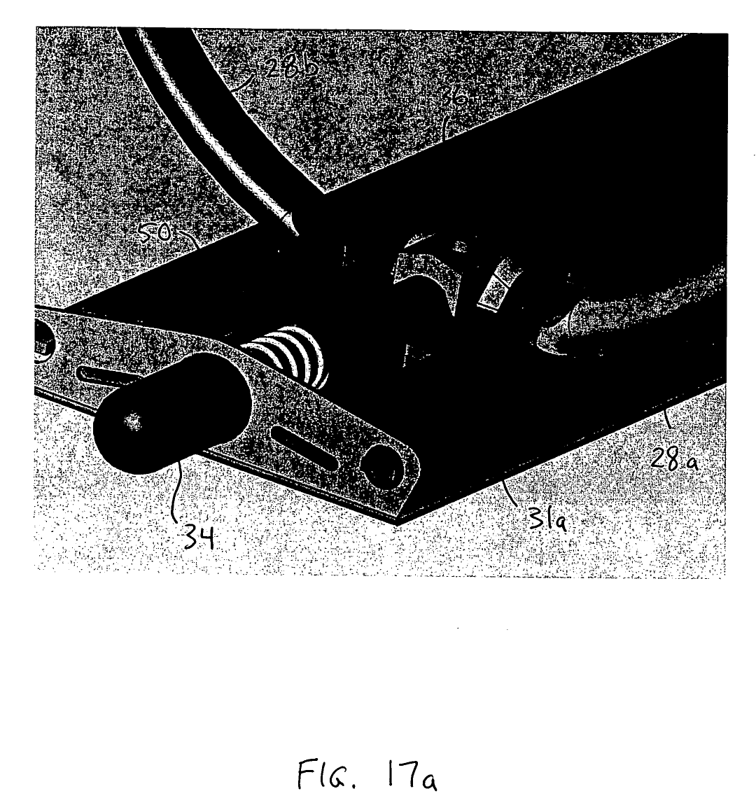

Biasing means 32 (as seen in FIGS. 3 and 6), in the form of coiled spring members 32a, 32b are provided (as seen in FIGS. 2, 3, 5, 6 and 10), so as to bias the rotatable members 24a, 24b respectively, into a desired position, either where the half-ring elements 28a, 28b are in a closed position, or preferably, where the half-ring elements 28a, 28b are in an open position. Such biasing means 32 may be coiled compression springs 32a, 32b, or alternatively may be resiliently flexible members, or even torsional springs. An alternative spring mechanism is illustrated in FIGS. 16a and 16b. In preferred embodiments the biasing means 32 (spring members 32a, 32b) are situate beneath the plate members 25a,25b, as shown in FIGS. 2, 3, 5, 6, 16a and 16b, so as to be compressed upon the closing of the half-ring elements 28a,28b, thereby resiliently biasing the half-ring elements 28a, 28b to an open position as shown in FIGS. 5, 6 and 16b.

Alternatively, the spring members 32a, 32b may be situate on the upper side of the plate members 25a, 25b (not shown), and adapted to be stretched upon closing of the half-ring elements 28a, 28b, thereby similarly biasing the half-ring elements 28a, 28b to an open position.

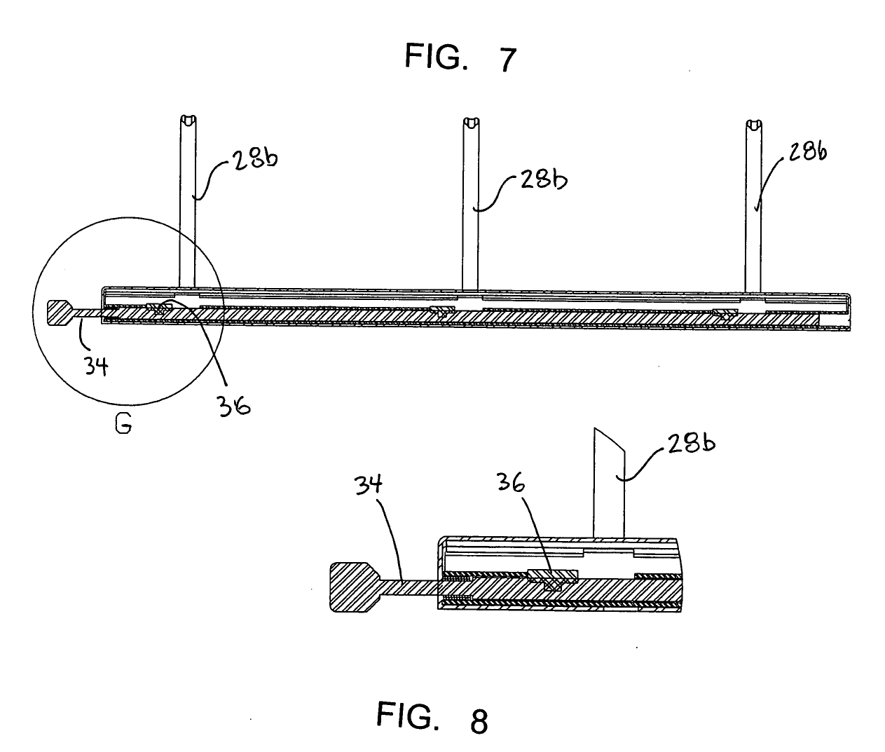

As seen most clearly in FIGS. 2, 5, 7 and 12, an elongate release-rod member 34 is provided, having one or more locking tabs 36 thereon corresponding in number to the number of protuberance tabs 31a, 31b. Such release-rod member 34 is slidably displaceable in a direction parallel the longitudinal axis 27a, 27b of the plate members 25a, 25b.

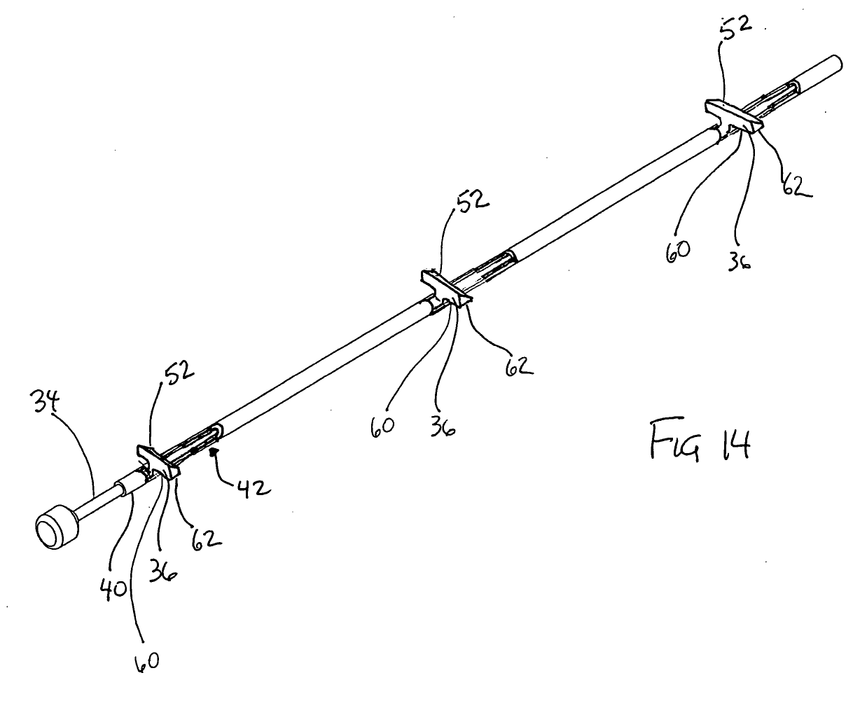

As can best be seen in FIGS. 2, 5, 10 and 13, the release-rod member 34 is typically longitudinally slidable within a cylindrical tube 40. The tube 40 is provided with apertures 42 to permit the locking tabs 36 affixed to the release-rod member 34 to move longitudinally yet be guided by the tube 40.

The operation of the binder mechanism 22 to open and close the binder mechanism 22 will now be described with reference to the drawings.

With reference to FIGS. 1 to 3, starting with the binder mechanism 22 and half-ring elements 28a, 28b in a closed position as shown in FIG. 1, the plate members 25a, 25b, as shown in FIG. 2 have compressed spring members 32a, 32b and are maintained in such position by locking tabs 36 on release-rod member 34 being in a position to engage and retain the protuberance tabs 31a, 31b. This is best shown in FIG. 12.

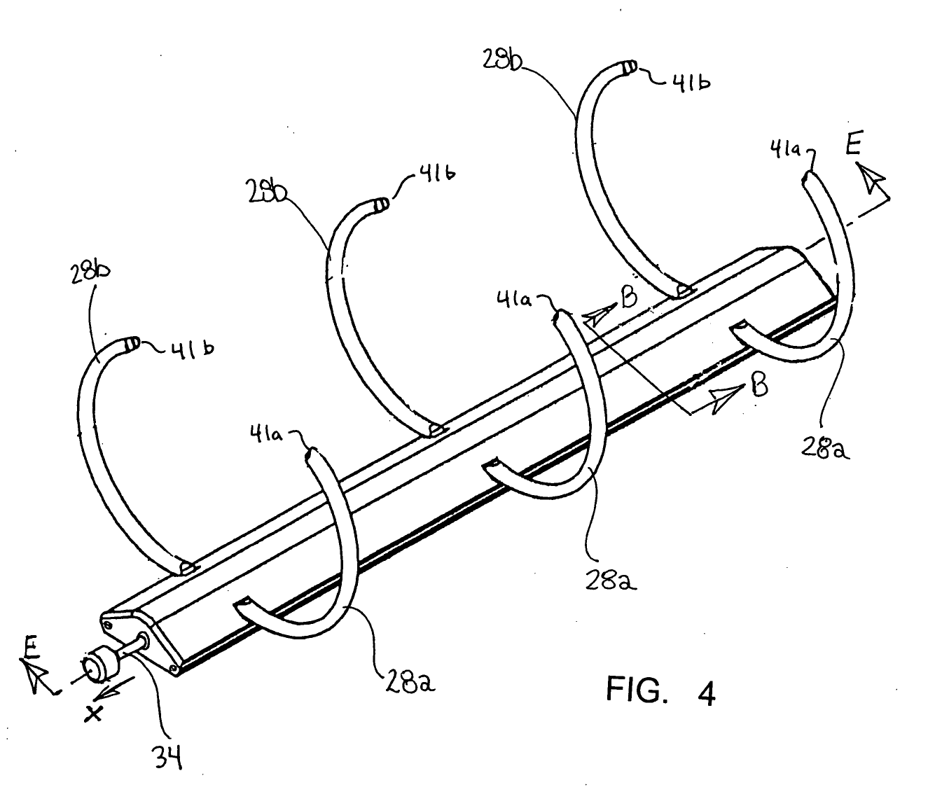

The manner of opening the half-ring elements 28a, 28b may be seen in FIGS. 4 to 8 inclusive. In particular, as shown in FIG. 4, the release-rod member 34 is slidably extended in the direction of arrow “X” (see FIG. 4) so as to pull the locking tabs 36 from engagement with the protuberance tabs 31a, 31b. FIG. 11 particularly shows the locking tabs 36 being removed from locking engagement with the protuberance tabs 31a, 31b by the slidable extension of the release-rod member 34 from within the tube 40. The compression springs 32a, 32b, now cause the plate members 25a, 25b to rotate about a longitudinal axis 27a, 27b respectively, thereby causing the distal ends 41a, 41b of the half-ring elements 28a, 28b to be separated from engagement, thereby opening half-ring elements 28a, 28b.

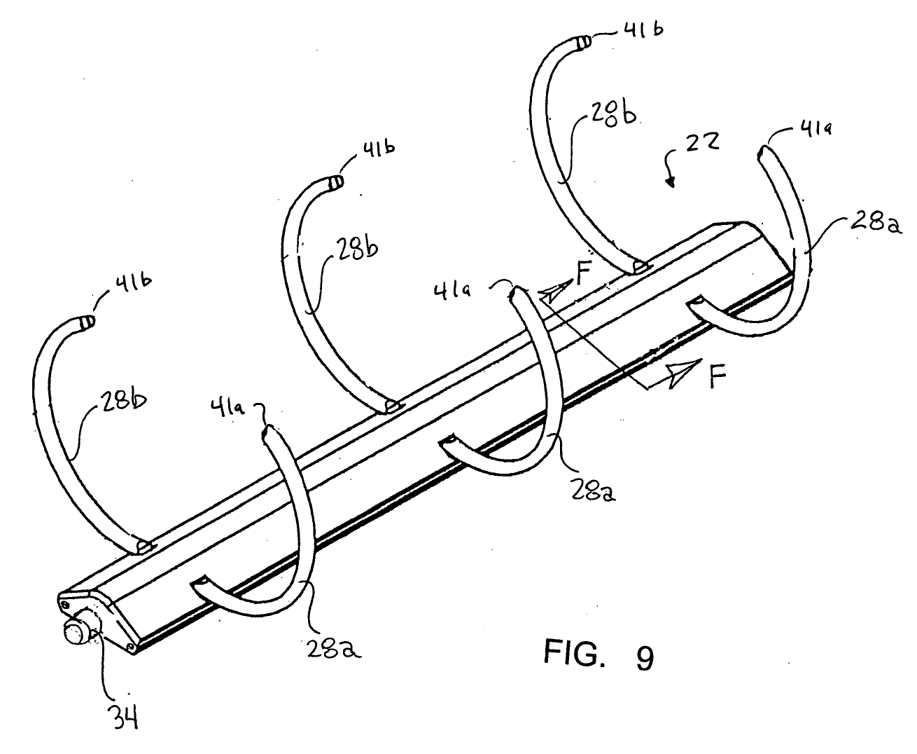

The release-rod member 34 is biased by a helical compression spring 50, shown in FIGS. 11 and 12, biasing the release-rod member 34 to a retracted position within the tube 40 wherein the locking tabs 36 return to their original position as shown in FIGS. 9 and 10.

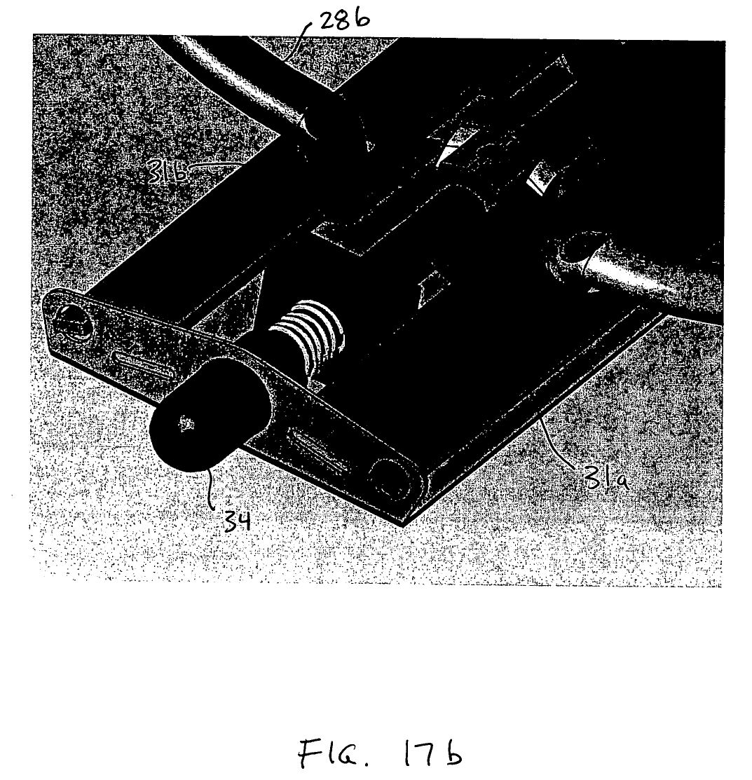

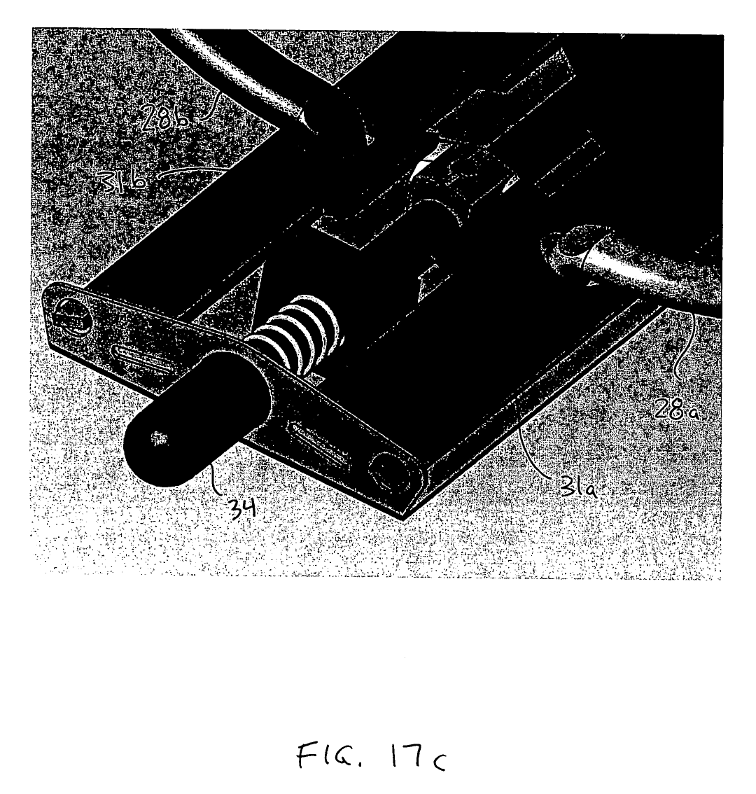

An alternative biasing arrangement is illustrated in FIGS. 17a to 17c, wherein the compression spring 50 is situate adjacent the actuating end of the release-rod member 34, such that pushing the release-rod member 34 inwardly (thereby inserting it further within the tube 40) causes the locking tabs 36 to disengage from the protuberance tabs 31a, 31b. FIG. 17a illustrates the starting position, with the locking tabs 36 engaged with the protuberance tabs 31a, 31b; FIG. 17b illustrates the release of the locking tabs 36 caused by the pushing of the release-rod member 34; and FIG. 17c illustrates the biased return of the release-rod member 34 after release of the locking tabs 36.

To close the half-ring elements 28a, 28b, in a first embodiment where the locking tabs 36 have the configuration shown in FIGS. 2, 3, 5, 6, 10, 11 and 12, each of the half-ring elements 28a, 28b are manually pushed towards each other. The protuberance tabs 31a, 31b, which are somewhat deformably flexible, “snap” over the locking tabs 36 and thereafter become held beneath the locking tabs 36, whereupon the manual pressure exerted to close the half-ring elements 28a, 28b can be removed.

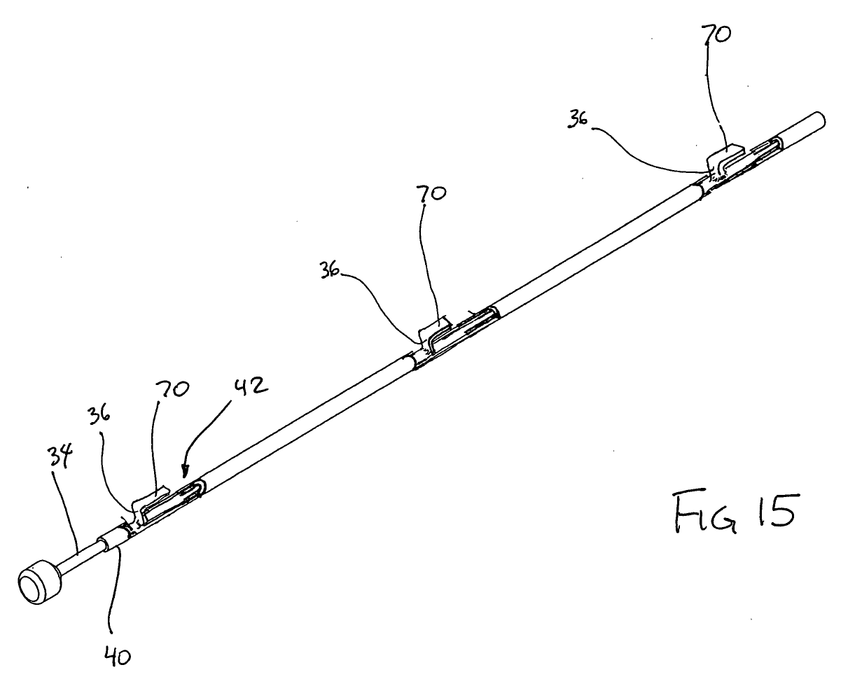

In an alternative embodiment of the invention, which is of importance during the closing of the half-ring elements 28a, 28b, the protuberance tabs 31a, 31b are not resiliently deformable so as to permit “snap” engagement with the locking tabs 36, but the locking tabs 36 instead have an upper inclined bearing surface 52, as shown in FIG. 14, which is adapted to be contacted by the protuberance tabs 31a, 31b when the half-ring elements 28a, 28b are moved to a closed position. In such embodiment, when the half-ring elements 28a, 28b are moved to a closed position, the protuberance tabs 31a, 31b contact the bearing surface 52, forcing the release-rod member 34 to be slidably displaced and to extend from the tube 40 so as to permit further downward movement of the protuberance tabs 31a, 31b. Thereafter, upon further downward movement of the protuberance tabs 31a,31b during further manual closing pressure being continued to be applied to the half-ring elements 28a, 28b, the protuberance tabs 31a, 31b, are then in a position within a recessed area 60 on the locking tab 36 so as to permit the release-rod member 34 to return to its original position, and the underside 62 of the bearing surface 52 retains the protuberance tabs 31a, 31b so as to retain the half-ring elements 28a, 28b in a closed position and resisting opening due to biasing of the compression springs 32a, 32b.

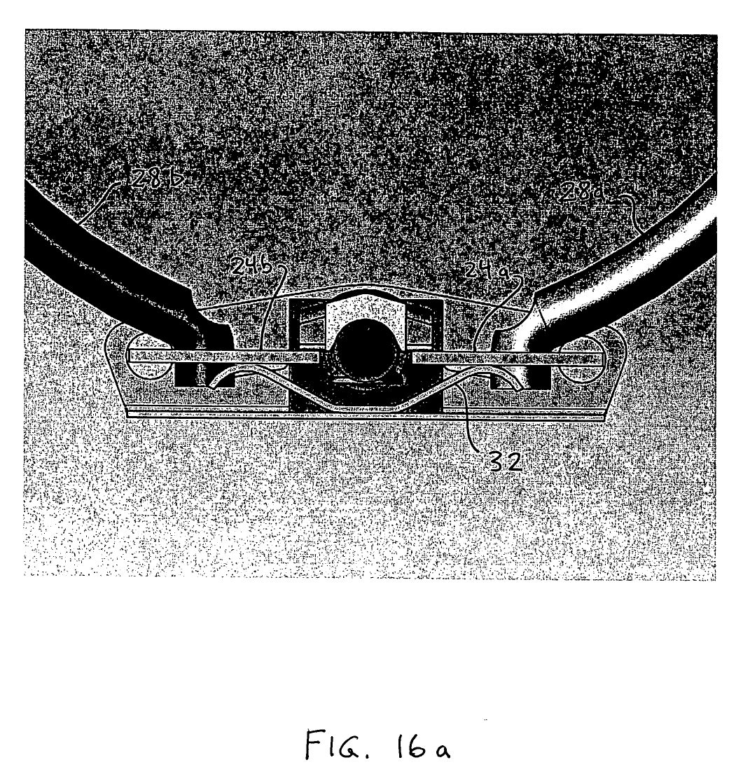

In yet another alternative embodiment of the invention, which is of importance during the closing of the half-ring elements 28a, 28b, the locking tabs 36 on the release-rod member 34 have a configuration as shown in FIG. 15. Specifically, such locking tabs 36 have a “hook-like” projection 70 which is capable of restraining the protuberance tabs 31a, 31b from upward movement. With this embodiment the protuberance tabs 31a, 31b need not be, and are not, resiliently deformable, nor do the locking tabs 36 have an inclined bearing surface 52. Instead, when the half-ring elements 28a, 28b are manually closed, the release-rod member 34 (and in particular the locking tabs 36 thereof) must be slidably manually extended from the tube 40 so as to allow the protuberance tabs 31a, 31b to move fully downwardly so as to be in a position below the hook-like projection 70 and so as to permit the half-ring elements 28a, 28b to be fully closed, whereupon the release-rod member 34 may be allowed, due to its being resiliently biased by helical spring 50, to attain a retracted position within the tube 40.

While a particular embodiment of the present invention has been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiment. The invention is therefore to be considered limited solely by the scope of the appended claims.

1. A ring binder mechanism for retaining perforated material in a binder, the mechanism comprising:
a pair of members arranged in juxtaposed position, each having a plurality of half-ring elements thereon, at least one of the members being a rotatable member pivotably rotatable about a longitudinal axis, each of the half-ring elements spaced on the members such that each half-ring element on each member, upon pivotable rotation of the at least one rotatable member, may be pivoted into or out of contact with a mutually opposite half-ring element on a respective opposite member;
protuberance means situate on the at least one rotatable member along an inner edge thereof;
biasing means, biasing the at least one rotatable member into an open position wherein distal ends of respective pairs of half-ring elements are not in contact;
a release-rod member, slidably displaceable in a direction parallel the longitudinal axis; and
locking tab means on the release-rod member;
wherein the release-rod member may be slidably displaced between a first position wherein the locking tab means are in engagement with the protuberance means such that the distal ends of respective pairs of half-ring elements are in contact, and a second position wherein the locking tab means are out of engagement with the protuberance means such that the distal ends of respective pairs of half-ring elements are not in contact.

2. The ring binder mechanism of claim 1 wherein the protuberance means, when the half-ring elements are moved into contact with each other, may be snap-fitted into locking engagement with the locking tab means so as to permit the locking tab means to retain the members and half-ring elements thereon in a closed position.

3. The ring binder mechanism of claim 1 wherein the locking tab means have an upper inclined bearing surface adapted to be contacted by the protuberance means when the half-ring elements are moved into contact with each other, so as to cause slideable displacement of the release-rod member in a direction parallel the longitudinal axis.

4. The ring binder mechanism of claim 1 wherein the release-rod member is resiliently biased to the first position whereby the locking tab means may engage the protuberance means and prevent pivotable rotation of the at least one rotatable member.

5. The ring binder mechanism of claim 3 wherein the release-rod member is resiliently biased to the first position whereby the locking tab means may engage the protuberance means when the half-ring elements are in the closed position, wherein moving the half-ring elements from an open position to the closed position causes the protuberance means to contact the upper inclined bearing surface causing the release-rod member to be slidably displaced so as to permit the half-ring elements to move to the closed position, whereupon the release-rod member is subsequently biased to the first position permitting the locking tab means thereon to fully engage the protuberance means and thereby retain the half-ring elements in the closed position.

6. The ring binder mechanism of claim 1 wherein the pair of members are elongate and generally parallel.

7. The ring binder mechanism of claim 1 wherein both of the pair of members are rotatable.

8. The ring binder mechanism of claim 1 wherein the biasing means is a compression spring.

9. The ring binder mechanism of claim 8 wherein the compression spring is situate beneath the rotatable member.

10. The ring binder mechanism of claim 1 wherein the release-rod member is housed within a generally cylindrical housing.

11. The ring binder mechanism of claim 10 wherein the generally cylindrical housing comprises at least one aperture for allowing lateral movement of the locking tab means.

12. The ring binder mechanism of claim 1 wherein the locking tab means comprise an upwardly extending element having side extensions for retaining the protuberance means when engaged.

13. The ring binder mechanism of claim 4 wherein the release-rod member is resiliently biased to the first position by means of a compression spring.

14. A ring binder for retaining perforated material therein, comprising:
a substantially flat, foldable binder member comprising:
i) a spine portion; and
ii) substantially similarly-sized top and bottom members, each attached to the spine portion on opposite edges thereof, the top and bottom members adapted to be folded over onto each other with the spine portion intermediate; and
a ring binder mechanism affixed to the spine portion of the binder member, comprising:
i) a pair of members arranged in juxtaposed position, each having a plurality of half-ring elements thereon, at least one of the members being a rotatable member pivotably rotatable about a longitudinal axis, each of the half-ring elements spaced on the members such that each half-ring element on each member, upon pivotable rotation of the at least one rotatable member, may be pivoted into or out of contact with a mutually opposite half-ring element on a respective opposite member;
ii) protuberance means situate on the at least one rotatable member along an inner edge thereof;
iii) biasing means, biasing the at least one rotatable member into an open position wherein distal ends of respective pairs of half-ring elements are not in contact;
iv) a release-rod member, slidably displaceable in a direction parallel the longitudinal axis; and
v) locking tab means on the release-rod member;
wherein the release-rod member may be slidably displaced between a first position wherein the locking tab means are in engagement with the protuberance means such that the distal ends of respective pairs of half-ring elements are in contact, and a second position wherein the locking tab means are out of engagement with the protuberance means such that the distal ends of respective pairs of half-ring elements are not in contact.

15. The ring binder of claim 14 wherein both of the pair of members are rotatable.

16. The ring binder of claim 14 wherein the biasing means is a compression spring.

17. The ring binder of claim 14 wherein the release-rod member is housed within a generally cylindrical housing.

18. The ring binder of claim 17 wherein the generally cylindrical housing comprises at least one aperture for allowing lateral movement of the locking tab means.

19. The ring binder of claim 14 wherein the locking tab means comprise an upwardly extending element having side extensions for retaining the protuberance means when engaged.

20. A ring binder for retaining perforated material therein, comprising:
a substantially flat, foldable binder member comprising:
i) an elongate spine portion; and
ii) substantially similarly-sized top and bottom members, each attached to the spine portion at opposite edges thereof, the top and bottom members adapted to be folded over onto each other with the spine portion intermediate; and
a ring binder mechanism affixed to the spine portion of the binder member, comprising:
i) a pair of elongate rotatable plates arranged in juxtaposed position, each having a plurality of half-ring elements thereon, the rotatable plates pivotably rotatable about respective and generally parallel longitudinal axes, each of the half-ring elements spaced on the rotatable plates such that each half-ring element on each rotatable plate, upon pivotable rotation of the rotatable plates, may be pivoted into or out of contact with a mutually opposite half-ring element on a respective opposite rotatable plate;
ii) protuberances situate on the rotatable plates along and integrally formed with inner edges thereof;
iii) springs situate beneath the rotatable plates and biasing the rotatable plates into an open position wherein distal ends of respective pairs of half-ring elements are not in contact;
iv) a release-rod, slidably displaceable in a direction parallel the longitudinal axes, the release-rod housed within a generally cylindrical housing, the release-rod resiliently biased by a spring into a first position; and
v) locking tabs on the release-rod, the locking tabs extending outwardly from the cylindrical housing by means of apertures in the cylindrical housing;
wherein the release-rod may be slidably displaced between the first position wherein the locking tabs are in engagement with the protuberances such that the distal ends of respective pairs of half-ring elements are in contact, and a second position wherein the locking tabs are out of engagement with the protuberances such that the distal ends of respective pairs of half-ring elements are not in contact.
